(19) United States
(12) Patent Application Publication
(10) Pub. No.: US 2026/0177803 A1
(43) Pub. Date: Jun. 25, 2026

(54) SYSTEM FOR THE DETECTION OF AIRBORNE VIRUSES

(71) Applicant: THE EUROPEAN UNION, REPRESENTED BY THE EUROPEAN COMMISSION, Brussels (BE)

(72) Inventors: Andrea BARBAGLIA, Brussels (BE); Andrea VALSESIA, Brussels (BE); Laura MARTINEZ SANCHEZ, Brussels (BE); Diletta SCACCABAROZZI, Brussels (BE); Giuditta GUERRINI, Brussels (BE)

(21) Appl. No.: 19/128,689

(22) PCT Filed: Nov. 10, 2023
(86) PCT No.: PCT/EP2023/081431

§ 371 Date: May 9, 2025

(30) Foreign Application Priority Data
Nov. 10, 2022 (EP) 22206623.5

(51) Int. Cl. G02B 21/36; G01N 21/65; G02B 21/00

(52) U.S. Cl. CPC G02B 21/367; G01N 21/65; G02B 21/00; G02B 21/0032; G02B 21/0076; G02B 21/008

(57) ABSTRACT

A system for the detection of airborne viruses is disclosed. The system comprises at least one local detector, the local detector comprising an aerosol collection module arranged to gather the particulate matter from the aerosol sample onto a collection chip, an analysis module arranged for detecting the amount of the viruses that are part of the particulate matter contained in the collected aerosol sample, and an output module arranged to emit a warning signal when the total viral content surpasses a predetermined threshold.

### TECHNICAL FIELD

The present invention relates to a system and method for the detection of airborne viruses.

### BACKGROUND

It is known that an airborne virus epidemic, such as those of SARS-CoV-2, origins from local outbreaks. In most of the airborne viral diseases, the infectivity is antecedent to the symptomatic phase. In the so-called latent phase, the epidemic is not recognized, but the concentration of viruses in indoor environments can be potentially already very high. In the case of SARS-CoV-2, the latent phase lasts on average a couple of days. On a time scale of a few weeks, local outbreaks can surge in nearby centers and spread, giving rise to a regional epidemic. If the epidemic is caused by an unidentified virus (whether because the virus is new, as a result for example of a zoonotic event or a virus mutation, or it was not expected in that geographical area), the epidemic is typically not recognized until this time-point, where a sufficient number of clinical cases are reported to alert the health authorities. Moreover, the clinical similarity with more common diseases can contribute to this time lag. Furthermore, at the current state-of-the-art, the recognition of an epidemic often involves pathogen isolation and its genetic sequencing, which can take several weeks. It is worth to note that, moreover, the same delay occurred in discovering virus variants, such as the SARS-CoV-2 Delta variant in December 2020 and the SARS-CoV-2 Omicron variant in November 2021.

It has furthermore been recognized that the main route for infection is the air, in particular in indoor environments, where a few infected individuals in a room are able to produce a concentration of viral particles which is enough to infect other people. They are also very persistent in the air in the form of aerosols.

The international community is looking for systems that can efficiently contrast virus spreading in both the scenarios above described, when the epidemic is not recognized. In the case of local outbreaks, the ideal virus sensor has to be able to detect virus presence within the latency window, in order to alert in due time on virus presence and thus interrupt virus transmission. In the case of a regional epidemic, typically caused by a new or unexpected virus, the ideal sensor has to be able to detect, on a temporal scale below few weeks, also new, unexpected and potentially harmful viruses. This could allow containing virus diffusion into a regional level, mitigating its effects and preventing its transformation into a pandemic.

Currently, there are no means to revealing both unrecognized local outbreaks and regional epidemics in a useful timeframe. Current technologies, in fact, cannot measure the concentration of airborne viruses with a temporal response able to resolve the latent phase, and meanwhile inform reliably on the presence of new, unidentified viruses on a temporal scale shorter than few weeks. In this perspective, state-of-art virus detection methods have all some drawbacks. In brief, methods based on PCR take longer time than the latency period and can only detect already known viruses. Methods based on immunoassays are faster than PCR, but significantly less sensitive, and again able to detect only known viruses. Finally, methods based on cell culture assays allow detecting unknown viruses, but they require several days, as well as specialized laboratory equipment and personnel that make them impractical.

A system capable of airborne virus detection with fast-response and that can monitor unidentified viruses in due time is still missing. Such a system could act as a new global surveillance sensor, as it could allow interrupting in due time local outbreaks, as well as confining epidemics caused by unidentified viruses at a regional scale.

### DESCRIPTION OF THE INVENTION

The present invention aims to provide a system and a method for the detection of airborne viruses wherein the problems of the prior art are overcome. The invention in particular provides a system and a method for the detection of unknown airborne viruses or variants of known airborne viruses, preferably variants of known airborne viruses, with fast-response, in some embodiments near real-time response.

To that end, the present invention provides the system according to the first claim. The system is arranged for the detection of airborne viruses. It is preferably arranged for the detection of unknown airborne viruses and variants of known airborne viruses. The system is preferably arranged for the fast detection of airborne viruses, for example near real-time. This enables to provide real time warnings to interrupt local outbreak propagation or to inform on the presence of an unknown epidemic in a confined geographical region. The system comprises at least one local detector, and preferably multiple local detectors as will be described further below. The local detector comprises the following modules:
An aerosol collection module arranged to collect an aerosol sample from the air. The aerosol collection module samples the air surrounding the local detector. Preferably the local detector is positioned indoors, and the air sample is thus an indoor air sample. The aerosol sample comprises particulate matter such as viruses and dust. The local detector needs to be able to distinguish virus particles from the other particles. How the local detector does this will be explained further below. The aerosol collection module is further arranged to gather the particulate matter from the aerosol sample onto a collection chip. The collection chip is for example a surface on which the particles can be collected in a dried manner. Alternatively, the collection chip is a liquid reservoir in which the particulate matter is collected in a wet manner. Providing a wet reservoir rather than a dry collection surface has the advantage that more parameters of the particulate matter can be observed, as will be explained below.
An analysis module arranged for detecting the amount of the viruses that are part of the particulate matter contained in the collected aerosol sample. The analysis module comprises an optical microscope. The optical microscope can be a label-free optical microscope. By providing a label-free optical microscope, one does not have to apply time consuming staining procedures, which would yield a slow response of the local detector. The optical microscope, according to embodiments label-free optical microscope, furthermore has the advantage that unknown viruses and variants of known viruses can be detected, because the detection method does not require genetic information of the viruses such as DNA sequences of the viruses. The optical microscope, according to embodiments label-free optical microscope, is arranged for performing the steps of:
   determining geometric and optionally dynamic parameters of particulate matter contained in the aerosol sample. The geometric parameters are for example the size and shape of the particles. The dynamic parameters are for example the diffusion coefficient of the particles. The dynamic parameters, in particular the diffusion coefficient are in particular advantageous when the collection chip is a liquid reservoir as described above.
   selecting, based on the determined parameters, candidate viral particles from the particulate matter. The selection for example takes into account typical geometric and/or dynamic parameters of viruses. At this stage one does not need to know what kind of virus is detected. One is merely interested in determining whether the particle has properties which are indicative of viruses. Preferably the local detector therefore has a database with reference parameter values which are indicative of viruses. Preferably the reference parameter values are indicative of human carried viruses.
   performing optical spectral measurements on the candidate viral particles,
   comparing for each candidate viral particle the obtained optical spectrum with a set of predetermined reference optical spectra corresponding to viruses in order to determine whether the candidate viral particle is a virus. Also at this stage one does not need to know what kind of virus is detected. One is merely interested in determining whether the particle has properties which are indicative of viruses. Preferably the local detector therefore has a database with reference optical spectra which are indicative of viruses. Preferably the reference optical spectra are indicative of human carried viruses.
   determining based on the comparison step the number of detected viruses, i.e. the “total viral content” (TVC) in the aerosol sample,
An output module, wherein the output module is arranged to emit a warning signal when the TVC surpasses a predetermined threshold.

An infected person in a room can emit viruses by breathing, speaking, coughing, and sneezing. Moreover, some individuals, known as superspreaders, have greater potential of emitting viruses in their exhaled breath. It is known in the literature that a fraction of the exhaled viruses stays volatile and distributes in the air of the environment. When an infected person comes near the local detector, for example within the same room as the local detector, those viruses are collected by the system within the same room or environment. The rise in TVC can thus indicate the presence of an infected person, or of a so called “superspreader”. Subsequently, it allows moreover prompting successive biological analysis on collected virus samples (whether from the aerosol or involved people). For example, virus sequencing towards the identification of a new variant.

According to an embodiment of the present invention, the system as described above is further configured for the classification of the detected viruses according to their virus families such as the coronavirus family or the influenza virus family. Preferably, to that end the collection chip of the aerosol collection module comprises predefined areas that are each functionalized with virus receptors of one specific virus family. Preferably, the optical microscope is further arranged for performing the step of:
counting the number of detected viruses in each predefined area, such as to determine the “family viral content” (FVC) in the aerosol sample.

The present embodiment has the advantage of enabling to classify detected viruses according to their virus family without requiring the specific genetic information of the virus variant. One merely uses virus receptors that have a binding affinity with the generic virus family. Based on this family classification one can take into account the potential hazards of different virus families prior to emitting a warning signal. One can for example set a higher FVC thresholds for a less harmful virus family. According to an embodiment of the present invention, the output module is further arranged to emit a warning signal when the FVC of a predetermined virus family surpasses a predetermined threshold of viral content for said virus family. Furthermore, information on the virus families allows to take the most appropriate countermeasures (for example testing involved people with appropriate swab-test, suggest isolation or self-observation by e.g. wearing protective mask, etc.).

According to an embodiment of the present invention, the aerosol collection module comprises a “condensation growth tube” (CGT). In the collection stage of the aerosol particles, which takes place in the aerosol collection module, it is important that the collection process preserves the integrity of the viral particles. A promising approach to preserve said integrity, is by using the well-established CGT technology which allows for gentle sampling by growing a water droplet around each collected particle. According to an embodiment of the present invention, a size-selection cyclone can be moreover implemented on top of the CGT. The size-selection cyclone selects particles with size lower than a cutoff. It allows to cut off big particles, which can interfere in the measurement.

According to an embodiment of the present invention, the analysis module performs the analysis directly on the collection chip. This ensures that less particles in the sample are lost, for example in comparison to an analysis module that requires transfer of the sample from the collection chip into the analysis module. This embodiment thus allows to use substantially all of the sample for the analysis, which results in a better virus detection. This embodiment increases the overall virus detection sensitivity.

According to an embodiment of the present invention, the analysis module performs the step of selecting candidate viral particles and/or the step of determining the TVC by means of Artificial Intelligence (AI). This enables fully automatic detection, fast response, and interconnection between different local detectors for continuous learning how to identify which particles are viruses and which ones are not. Preferably, the encoder/decoder algorithm relying on semantic segmentation performs automatic particles detection from the acquired microscopy images. Thereafter, those detections are preferably ingested to an algorithm that detects the areas with higher intensity of those particles to extract geometric and optionally dynamic parameters for each particle, as well as their optical spectra. With these parameters, the algorithm performs automatic spectra analysis and calculates the TVC index, using, for example, PCA or Regression models. Moreover, where virus family classification is required, a second AI algorithm, based on image classification, automatically counts viruses linked to their receptors and calculates the FVC indexes.

According to an embodiment of the present invention, the geometric properties of the particulate matter comprise the shape and/or size of the particles. According to an embodiment of the present invention, the dynamic properties of the particulate matter comprise the diffusion coefficient of the particle.

According to an embodiment of the present invention, the analysis module performs the step of selecting candidate viral particles by selecting as candidate viral particles those particles that have geometric and optionally dynamic parameters compatible with those of viruses. Typical size range for viruses lies between 50 to 200 nm. Actually, it is not possible to measure optically those sizes due to the diffraction limit of light. Particles with size lower than approximately 200-300 nm will appear having the same size at the microscope. One can just select which particles have size lower than this limit and can thus be considered candidate viral particles. Alternatively one could use other, more complex approaches, such as Patterson 2008 “Optical Signatures of Small Nanoparticles in a Conventional Microscope”, which harnesses caustics signals. In general according to the present embodiment, if this size can be attributed to a particle lying in the range between 50 to 200 nm (i.e. the typical size range of viruses, where this range can be tuned to include also larger viruses), the particle is acknowledged as a candidate viral particle.

According to an embodiment of the present invention, the analysis module performs the comparison step based on reference optical spectra obtained through simulations such as Mie-scattering simulations, or through experiments. Alternatively, the analysis module performs the comparison step based on unsupervised learning of reference optical spectra, preferably using principal component analysis (PCA).

According to an embodiment of the present invention, the analysis module normalizes the measured spectra of the candidate viral particles with respect to a normalization spectrum measured from standard particles spotted on the same chip in a separate location. This operation allows to solve the problem that it is not possible to measure directly the absolute spectra of the particles due to intrinsic inhomogeneities of the systems, such as instabilities of the light source, presence of optical aberrations, discrepancies in the alignment of the different system components, for example the chip position with respect to the optical path. Therefore, a normalization spectrum has to be acquired for each measurement of particles spectra. The normalization of the particles spectra by a normalization spectrum allows eliminating these inhomogeneities, thus enabling the successive comparison between normalized measured spectra with predetermined reference optical spectra, already subjected to the same normalization process. The standard particles used to generate the normalization spectrum can be preferentially spherical polystyrene beads, with highly uniform size and shape, for example NIST Traceable Size Standards monodisperse polystyrene spheres. These particles are very stable and reproducible, which makes them an ideal standard reference material to obtain the normalization optical spectrum.

According to an embodiment of the present invention, the collection chip is a collection surface on which the particles are collected in a dry manner as explained above. Alternatively, the collection chip is a liquid collection container in which the particles are received as explained above. In the latter alternative, preferably dynamic parameters such as the diffusion coefficient of the particles are taken into account by the analysis module. According to an embodiment of the present invention, the collection chip comprises hydrophilic and hydrophobic areas. This enables to convey and concentrate aerosol particles in specific locations on the collection chip to facilitate the detection and characterization.

According to a first implementation of the present invention, the optical microscope in the analysis module is a “hyper-spectral enhanced dark-field” (HSEDF) microscope. The HSEDF microscope is preferably operated in transmission mode. According to an embodiment of the present invention, the analysis module performs the step of collecting optical spectral measurements on the candidate viral particles by obtaining an optical spectrum which is a scattering spectrum. Preferably, the obtaining of the scattering spectrum is contained in the hyper-spectral enhanced dark-field technique above cited, which measures for each pixel (and thus for each particle) a scattering spectrum.

According to a second implementation of the present invention, the optical microscope in the analysis module is a “hyper-spectral bright-field” (HSBF) microscope. The HSBF microscope is preferably operated in reflection mode. According to an embodiment of the present invention, the analysis module performs the step of performing optical spectral measurements on the candidate viral particles by obtaining an optical spectrum, which is a reflectance spectrum. Preferably, the collection chip of the aerosol collection module comprises nanometric cavities preferably fabricated by Focused Ion Beam. If a particle fills the nanometric cavity, the optical signal coming from the cavity, for example the above mentioned reflectance spectrum, changes due to wave optics principles. Preferably the nanometric cavities have size and shape comparable to those of viruses. Preferably, the nanometric cavities have a size, for example a diameter of between 100 nm and 1 μm, thereby enabling typical viruses to enter within the nanometric cavities whilst excluding larger particles. Preferably, the hydrophilic areas are located in correspondence of the nanometric cavities. Not just within, but also in the region in the close surroundings. This region will be preferred by the drops containing (viral) particles arriving on the collection chip. When a drop dries, it releases the particles inside the nanometric cavities where they can be detected.

According to an embodiment of the present invention, a region, i.e. a geographical region, is monitored by means of multiple local detectors. Preferably, the multiple local detectors are interconnected in a regional network. Preferably, the system is configured to correlate TVC and FVC from the different local detectors. In this way it could be possible, for example, to follow the dynamic evolution of an epidemic in a geographical region.

According to an embodiment of the present invention, the TVC of each local detector in the regional network is accumulated to a “regional TVC” (RTVC) and wherein the system is arranged to emit a warning signal when the RTVC surpasses a predetermined threshold. According to an embodiment of the present invention, the FVCs of each virus family of each local detector in the regional network are accumulated to “regional FVCs” (RFVC) of each virus family and wherein the system is arranged to emit a warning signal when the RFVC of a predetermined virus family surpasses a predetermined threshold of regional viral content for said virus family.

It is a further object of the present invention to provide for a method for detecting airborne viruses, preferably unknown airborne viruses or variants of known airborne viruses, more preferably variants of known airborne viruses, preferably in real-time. The method comprises the use of the system as described above.

As described above, the system is preferably arranged for the fast detection of airborne viruses, for example near real-time. The system could be seen as an artificial lung that has similar inflow as of our respiratory system. The reference “warning” dose could be the infectious dose, which is known in the literature to be approximately from few hundreds to few thousands of virions (virions, i.e. viruses that are infectious). On the other hand, the present system and related detection method can in principle detect single viral particles. However, for statistic robustness and reliable AI operation, one can consider that a good target number of collected viral particles is approximately between 100 and 1000, i.e. below (or, in any case, of the same order of) the infectious dose. Therefore, the present system can in principle detect the presence of airborne viruses before the inspired dose becomes infectious. One can think about the situation of a person entering a room where there is already a concentration of viruses in the air. Once entered, our sensor starts “breathing”: it can emit a warning signal before the dose of viruses inspired by the person becomes infectious. Anyhow, the system can be always on and monitor constantly the presence of viruses in an environment. To give some numbers, one can refer to Lednicky et al. “Viable SARS-CoV-2 in the air of a hospital room with COVID-19 patients” (2020), where it is measured that in a hospital room with two COVID-19 patients there are approx. 16÷94 viral particles/L, where approx. 6÷74 are viable viral particle/L. These viruses are homogenously dispersed in the air: they are very small and thus very mobile particles, which can remain suspended in the air for a very long time (hours). By using for example an aerosol sampling technology with sampling rate of 1.5 L/min, one can in principle collect the target number of particles in approximately between 2 to 20 minutes. Then, the AI analysis almost instantaneously processes the images and returns the number of particles that could be viruses. So one can say that the present system could give the alert in a useful time to prevent further contagion. This time is far more rapid than the gold standard method of PCR, and has further advantages than immunogenic assays or cell culture assays. In an embodiment, the system and related detection method can be considered real-time on the basis of the infectious dose concept and the possibility to stop the virus replication (or contagious) cycle. Considering the possibility to detect the presence of any virus in the environment, it can be considered near real-time depending on the concentration of viral particle in the environment.

### FIGURES

FIG. 1 is a schematic view of a local detector according to an embodiment of the present invention wherein the collection chip is a collection surface for collecting particles in a dry manner.

FIGS. 2a and 2b respectively show a side view and a top view of a collection chip used in the local detector of FIG. 1 wherein the collection chip is adapted for use with HSEDF microscopy.

FIGS. 3a and 3b respectively show a side view and a top view of a collection chip suitable for use in a local detector similar to the one shown in FIG. 1 wherein the HSEDF microscope would be replaced by a HSBF microscope, and wherein the collection chip is adapted for use with HSBF microscopy.

FIG. 4 is a schematic view of a local detector according to an embodiment of the present invention wherein the collection chip is a liquid collection reservoir for collecting particles.

FIGS. 5a and 5b respectively show a side view and a top view of a collection chip used in the local detector shown in FIG. 4, wherein the collection chip is adapted for use with HSEDF microscopy.

FIGS. 6a and 6b respectively show a Scanning Electron Microscopy (SEM) image of collected particulate matter spiked with Virus Like Particles (VLP), and an optical spectral measurement of the candidate viral particles, including VLP.

### BRIEF DESCRIPTION OF THE FIGURES

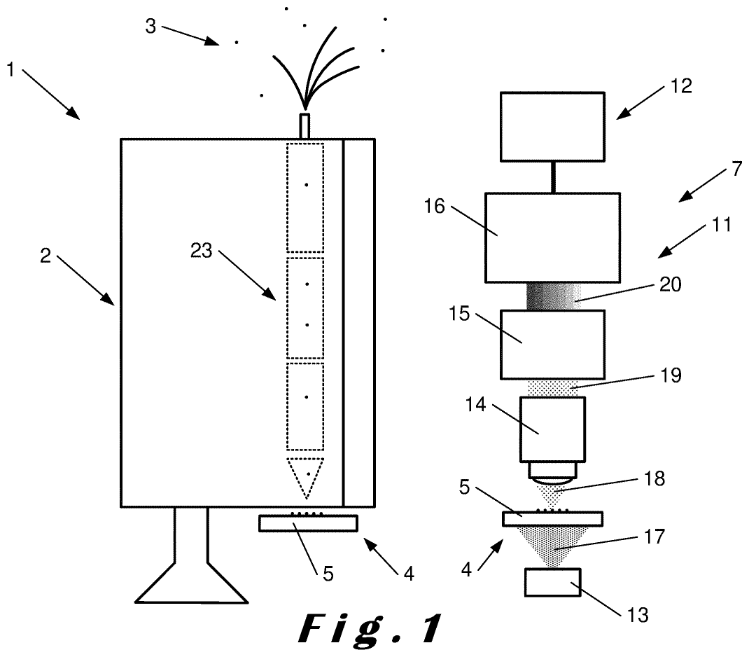

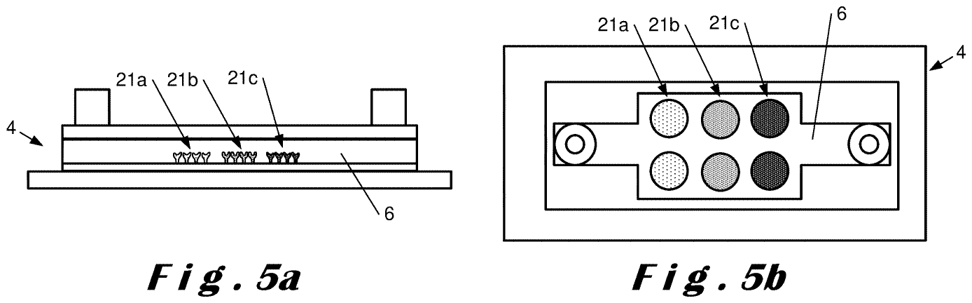

FIGS. 1 and 4 show embodiments of the system for the near real-time detection of unknown airborne viruses according to the present invention. The system enables to provide real time warnings to interrupt local outbreak propagation or to inform the presence of an unknown epidemic in a confined geographical region. The system comprises at least one local detector 1. The local detector 1 comprises the following modules: an aerosol collection module 2, an analysis module 7, and an output module 12.

The aerosol collection module 2 is arranged to collect an aerosol sample from the air 3. The aerosol sample comprises particulate matter such as viruses and dust. The aerosol collection module 2 is further arranged to gather the particulate matter from the aerosol sample onto a collection chip 4. The collection chip is for example a surface 5 on which the particles can be collected in a dried manner as is shown in FIG. 1. Alternatively, the collection chip 4 is a liquid reservoir 6 in which the particulate manner is collected in a wet manner as is shown in FIG. 4. The aerosol collection 2 module comprises a “condensation growth tube” (CGT) 23 in order to collect the particles.

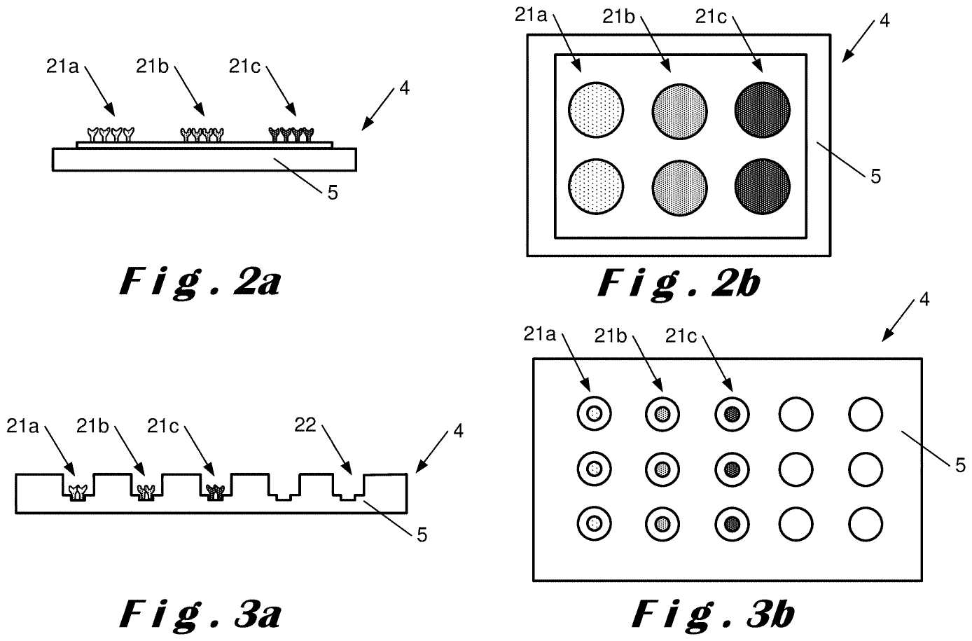

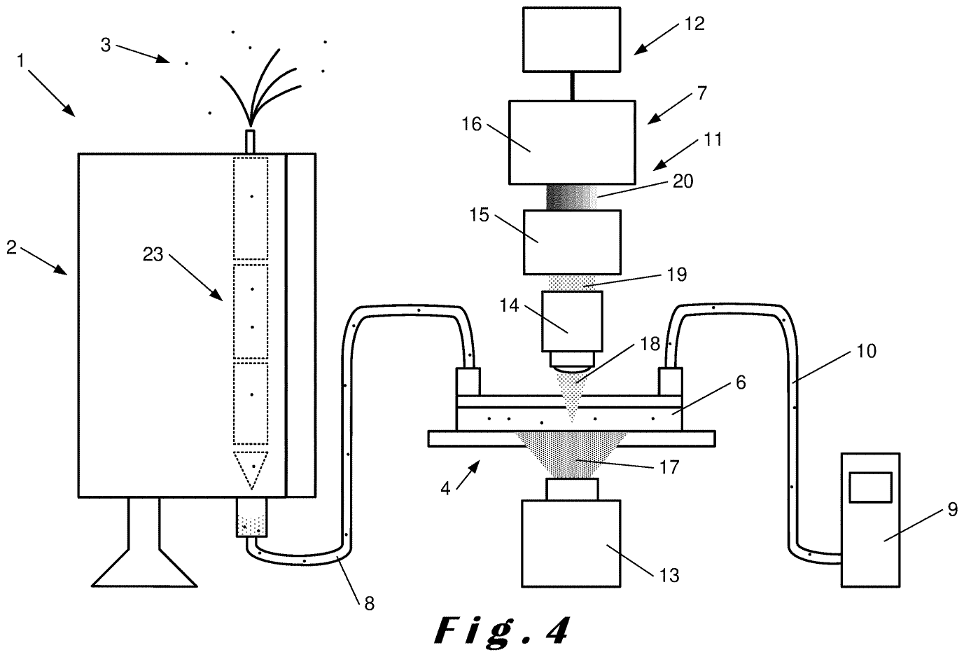

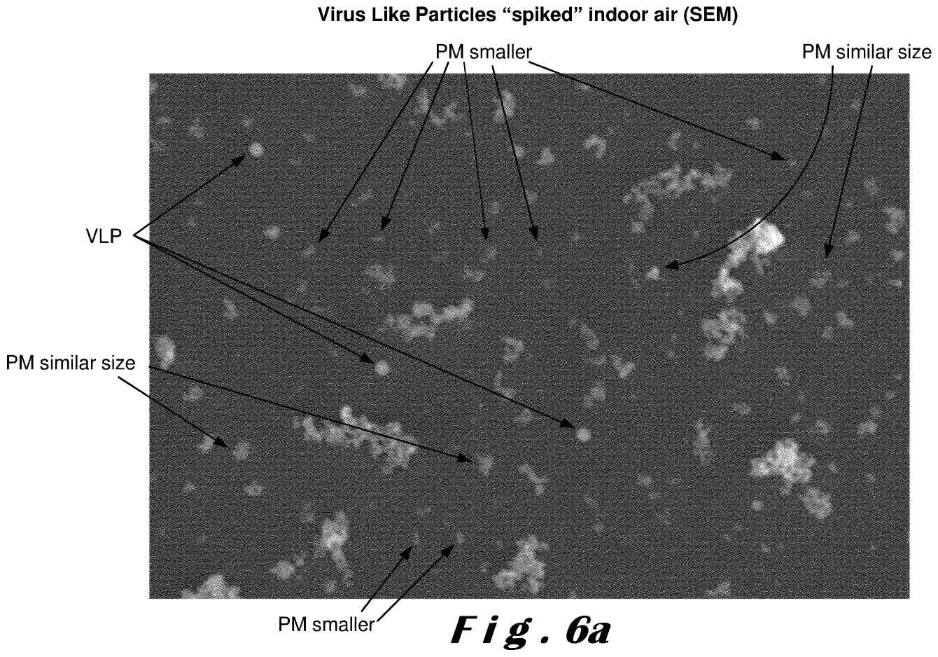

The analysis module 7 is arranged for detecting the amount of the viruses that are part of the particulate matter contained in the collected aerosol sample. In the dry collection embodiment shown in FIG. 1, the collection surface 5 is transferred from the collection module 2 to the analysis module 7. In other embodiment, which are not shown in the present figures, the collection chip is not transferred, but directly analyzed on the collection module by the analysis module, thereby creating a more integrated system. In the wet collection embodiment shown in FIG. 4, the liquid reservoir 6 is fixed to the analysis module and is in fluid communication with the aerosol collection module 2 by means of inflow tubing 8. The liquid and the sample comprised in the liquid are sucked from the aerosol collection module 2 through the inflow tubing 8 towards the liquid reservoir 6 by means of a pump 9 connected to the liquid reservoir 6 by means of outflow tubing 10. The analysis module comprises an optical microscope 11. The optical microscopes shown in FIGS. 1 and 4 are “hyper-spectral enhanced dark-field” (HSEDF) microscopes. The collection chips 4 used for such microscopes are shown in FIGS. 2 and 5. The collection chip 6 shown in FIG. 3 is suitable for use in a “hyper-spectral bright-field” (HSBF) microscope which is not shown in FIGS. 1 or 4. Such a HSEDF microscope is known in the state of the art and comprises an illumination source 13 emitting light 17 towards the sample, a microscope objective 14 receiving light 18 after interaction with the sample, an optical filter 15 receiving light 19 from the objective, and a camera 16 receiving light 20 that has passed through the optical filter 15 and that has been optically filtered by the optical filter 15 for the purpose of optical spectrum measurements. The optical microscope is arranged for performing the steps of:
determining geometric and optionally dynamic parameters of particulate matter contained in the aerosol sample. The geometric parameters are for example the size and shape of the particles. The dynamic parameters are for example the diffusion coefficient of the particles. The dynamic parameters, in particular the diffusion coefficient are in particular relevant when the collection chip 4 is a liquid reservoir 6 as described above.
selecting, based on the determined parameters, candidate viral particles from the particulate matter. The selection for example takes into account typical geometric and/or dynamic parameters of viruses. At this stage one does not need to know what kind of virus is detected. One is merely interested in determining whether the particle has properties which are indicative of viruses. The local detector 1 therefore has a database (for example associated to the camera 16) with reference parameter values which are indicative of viruses.
performing optical spectral measurements on the candidate viral particles, preferably by intermediary of the optical filter 15. The light 19 coming into the optical filter 15 is shown to comprise a mixture of frequencies. The light 20 exiting the optical filter 15 and entering the camera 16 is shown as separate frequency bands (wherein the darker light represents light of smaller wavelength than the lighter light) to indicate that the light has been optically filtered for performing optical spectral measurements.
comparing for each candidate viral particle the obtained optical spectrum with a set of predetermined reference optical spectra corresponding to viruses in order to determine whether the candidate viral particle is a virus. Also at this stage one does not need to know what kind of virus is detected. One is merely interested in determining whether the particle has properties which are indicative of viruses.
determining based on the comparison step the number of detected viruses, i.e. the “total viral content” (TVC) in the aerosol sample.

The analysis module 7 performs the above mentioned steps of selecting candidate viral particles and/or the step of determining the TVC by means of Artificial Intelligence.

The output module 12 is arranged to emit a warning signal when the TVC surpasses a predetermined threshold. It is known that an infected person can emit viruses by breathing, speaking, coughing, and sneezing. Moreover, some individuals, known as superspreaders, have greater potential of emitting viruses in their exhaled breath. It is known in the literature that a fraction of the exhaled viruses stays volatile and distributes in the air of the environment. When an infected person comes near the local detector, for example within the same room as the local detector, those viruses are collected by the system within the same room or environment. The rise in TVC can thus indicate the presence of an infected person, or of a so called “superspreader”.

The local detector 1 as described above is further configured for the classification of the detected viruses according to their virus families such as the coronavirus family or the influenza virus family. To that end the collection chip 4 of the aerosol collection module 2 comprises predefined areas 21a, 21b, 21c that are each functionalized with virus receptors of one specific virus family. This is shown in FIGS. 2, 3 and 5. In FIGS. 2 and 3 each virus family comprises two circular areas provided with dedicated receptors. In FIG. 3 each virus family comprises three circular areas provided with dedicated receptors. The number of areas is however not critical to the invention. In FIG. 3, the circular areas are provided within wells 22. The optical microscope 11 is arranged for performing the step of:
counting the number of detected viruses in each predefined area, such as to determine the “family viral content” (FVC) in the aerosol sample.

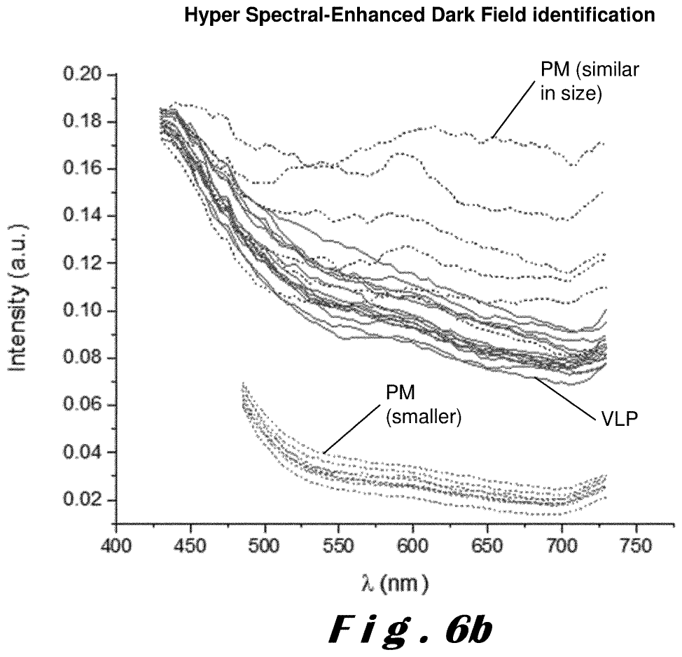

The SEM image of FIG. 6a, shows the particulate matter (PM) collected on the collection chip by the aerosol collection module in an environment spiked with VLP in 10 minutes time. The particles are well separated and distributed over the surface. The VLP are perfectly round and characterized by a typical size (100 nm in this case). In the air sample there are also other PM particles comprising particles with much larger size than the VLP, particles with smaller size than the VLP and particles with similar size as the VLP but with different shape and composition (and consequently a different refractive index) than the VLP. The different sizes of the particles enable to determine candidate virus particles, for example comprising the VLP and the other PM having a similar size as the VLP. The typical scattering spectra measured by HSEDF are shown in the graph of FIG. 6b (larger particles are not shown since they have very different spectra with one or more order of magnitude scattering intensity). Smaller particles show much lower scattering intensity. PM of similar size have different spectral shape (e.g. higher scattering intensity in the NIR region). This enables the present system to select viruses, in the present example VLPs, from other candidate virus particles.

1. A system for detection of airborne viruses, the system comprising at least one local detector, the local detector comprising:
an aerosol collection module arranged to collect an aerosol sample from the air, the aerosol sample comprising particulate matter such as viruses and dust, and further arranged to gather the particulate matter from the aerosol sample onto a collection chip, and
an analysis module arranged for detecting an amount of the viruses that are part of the particulate matter contained in the collected aerosol sample, the analysis module comprising an optical microscope arranged for performing the steps of:
determining geometric and optionally dynamic parameters of particulate matter contained in the aerosol sample,
selecting, based on the determined parameters, candidate viral particles from the particulate matter,
performing optical spectral measurements on the candidate viral particles, comparing for each candidate viral particle the obtained optical spectrum with a set of predetermined reference optical spectra corresponding to viruses in order to determine whether the candidate viral particle is a virus, and
determining based on the comparison step the number of detected viruses, i.e. the “total viral content” (TVC) in the aerosol sample, and
and an output module, wherein the output module is arranged to emit a warning signal when the TVC surpasses a predetermined threshold.

2. The system according to claim 1, further configured for a classification of the detected viruses according to their virus families such as the coronavirus family or the influenza virus family,
wherein the collection chip of the aerosol collection module comprises predefined areas that are each functionalized with virus receptors of one specific virus family, and
wherein the optical microscope is further arranged for performing the step of:
counting the number of detected viruses in each predefined area, such as to determine the “family viral content” (FVC) in the aerosol sample.

3. The system according to claim 1, wherein the analysis module performs the analysis directly on the collection chip.

4. The system according to claim 1, wherein the analysis module performs the normalization of the measured spectra with a normalization spectrum measured from standard particles spotted on the same collection chip in a separate location, wherein the normalized spectra are then compared to the reference spectra, already subjected to the same normalization process, and wherein the standard particles employed for generating the normalization spectrum are preferentially highly uniform monodisperse spherical polystyrene beads.

5. The system according to claim 1, wherein the collection chip is a collection surface on which the particles are collected in a dry manner.

6. The system according to claim 1, wherein the collection chip is a liquid collection container in which the particles are received.

7. The system according to claim 1, wherein the optical microscope in the analysis module is a “hyper-spectral enhanced dark-field” (HSEDF) microscope preferably operated in transmission mode.

8. The system according to claim 7 wherein the analysis module performs the step of collecting optical spectral measurements on the candidate viral particles by obtaining an optical spectrum which is a scattering spectrum.

9. The system according to claim 1, wherein the optical microscope in the analysis module is a “hyper-spectral bright-field” (HSBF) microscope preferably operated in reflection mode.

10. The system according to claim 9, wherein the analysis module performs the step of performing optical spectral measurements on the candidate viral particles by obtaining an optical spectrum which is a reflectance spectrum.

11. The system according to claim 9, wherein the collection chip of the aerosol collection module comprises nanometric cavities preferably fabricated by Focused Ion Beam.

12. The system according to claim 1, wherein a region is monitored by means of multiple local detectors, preferably interconnected in a regional network.

13. The system according to claim 12, wherein the TVC of each local detector in the regional network is accumulated to a “regional TVC” (RTVC) and wherein the system is arranged to emit a warning signal when the RTVC surpasses a predetermined threshold.

14. The system according to claim 2, wherein a region is monitored by means of multiple local detectors, preferably interconnected in a regional network, wherein the TVC of each local detector in the regional network is accumulated to a “regional TVC” (RTVC) and wherein the system is arranged to emit a warning signal when the RTVC surpasses a predetermined threshold, and wherein the FVCs of each virus family of each local detector in the regional network are accumulated to “regional FVCs” (RFVC) of each virus family and wherein the system is arranged to emit a warning signal when the RFVC of a predetermined virus family surpasses a predetermined threshold of regional viral content for said virus family.

15. The system according to claim 1, wherein the optical microscope is a label-free optical microscope.

16. The system according to claim 1, wherein the steps of determining geometric and optionally dynamic parameters of particulate matter contained in the aerosol sample and selecting, based on the determined parameters, candidate viral particles from the particulate matter is done by selecting particles having a size lower than 300 nm, preferably lower than 200 nm, more preferably in a range between 50 nm to 200 nm, from the particulate matter.

17. A method for detecting unknown airborne viruses or variants of known airborne viruses, preferably for detecting variants of known airborne viruses, the method comprising the use of the system according to claim 1.
